(19) United States
(12) Patent Application Publication
(10) Pub. No.: US 2025/0001935 A1
(43) Pub. Date: Jan. 2, 2025

(54) VEHICLE

(71) Applicant: TOYOTA JIDOSHA KABUSHIKI KAISHA, Aichi-ken (JP)

(72) Inventor: Yuri TAMURA, Santa Clara, CA (US)

(21) Appl. No.: 18/747,447

(22) Filed: Jun. 19, 2024

(30) Foreign Application Priority Data
Jun. 27, 2023 (JP) 2023-105317

(51) Int. Cl. B60Q 9/00; B60Q 3/217; B60Q 3/54; B60Q 3/70

(52) U.S. Cl. CPC B60Q 9/008; B60Q 3/217; B60Q 3/54; B60Q 3/70; B60Q 2500/00

(57) ABSTRACT

A vehicle includes: a display device that includes plural light-emitting bodies at a vehicle cabin inner side; and an interior material that has plural through holes penetrating in a thickness direction formed therein, and that is disposed at a vehicle cabin inner side of the display device so as to cover the display device.

### CROSS-REFERENCE TO RELATED APPLICATION

This application is based on and claims priority under 35 USC 119 from Japanese Patent Application No. 2023-105317, filed on Jun. 27, 2023, the disclosure of which is incorporated by reference herein.

### BACKGROUND

### Technical Field

The present disclosure relates to a vehicle.

### Related Art

International Publication (WO) No. 2022/085778 discloses a vehicle interior part including a light-emitting member that emits light toward a vehicle cabin interior. In the technology described in International Publication (WO) No. 2022/085778, a decorative panel made of resin is disposed at a vehicle cabin inner side of the light-emitting member. The decorative panel has a light-emitting region at a panel surface, and is configured to display a predetermined decorative pattern by being irradiated by the light-emitting member. On the other hand, the decorative panel is configured such that, when not being irradiated by the light-emitting member, the light-emitting region is turned off and matches with a surface of a door lining.

However, in the display described in International Publication (WO) No. 2022/085778, since light transmitted through the decorative panel reaches the vehicle cabin interior, there is room for improvement in displaying a clear image.

### SUMMARY

In consideration of the above circumstances, the present disclosure provides a vehicle that is capable of displaying a clear image at a vehicle cabin interior while maintaining design characteristics of the interior.

A vehicle according to a first aspect includes: a display device that includes plural light-emitting bodies at a vehicle cabin inner side; and an interior material that has plural through holes penetrating in a thickness direction formed therein, and that is disposed at a vehicle cabin inner side of the display device so as to cover the display device.

According to the vehicle of the first aspect, the display device is covered by the interior material. Thus, design characteristics of an interior when the light-emitting bodies are not emitting light can be maintained, compared to a case in which the display device is exposed within the vehicle cabin.

Further, light emitted from the light-emitting bodies of the display device passes through the through holes of the interior material and reaches a space within the vehicle cabin. Thus, compared to a case in which a panel having transparency is disposed at an inner side of the display device, since the light emitted from the light-emitting bodies directly reaches the space within the vehicle cabin, a clear image can be displayed within the vehicle cabin.

A vehicle according to a second aspect is the vehicle according to the first aspect, wherein the interior material is configured as a laminate body in which plural sheet-like members are superimposed in the thickness direction.

According to the vehicle of the second aspect, each sheet-like member is thin and freely bendable. Thus, by laminating the sheet-like members after bending them, strength of the interior member can be secured while conforming to a three-dimensional shape of the interior of the vehicle cabin.

A vehicle according to a third aspect is the vehicle according to the first aspect, wherein the interior material is provided at a door that is disposed at a side portion of the vehicle, and the through holes are configured as slits that each have a length direction thereof along a vehicle front-rear direction.

According to the vehicle of the third aspect, the slits of the interior member are formed along the vehicle front-rear direction at the door. Thus, light emitted so as to flow in the vehicle front-rear direction can be visually recognized by an occupant continuously without interruption.

A vehicle according to a fourth aspect is the vehicle according to the first aspect, wherein the interior material is provided at an instrument panel that extends in a vehicle width direction at a front portion of the vehicle cabin, and the through holes are configured as slits that each have a length direction thereof along the vehicle width direction.

According to the vehicle of the fourth aspect, the slits of the interior material are formed along the vehicle width direction at the instrument panel. Thus, light emitted so as to flow in the vehicle width direction can be visually recognized by an occupant continuously without interruption.

A vehicle according to a fifth aspect is the vehicle according to the first aspect, further including a periphery monitoring sensor that monitors a periphery of the vehicle, wherein the display device displays a warning in a case in which an obstacle has been detected at the periphery of the vehicle by the periphery monitoring sensor.

According to the fifth aspect, in a case in which an obstacle has been detected at the periphery of the vehicle by the periphery monitoring sensor, the warning is displayed at the display device. The occupant can visually recognize the warning display from the through holes formed at the interior material. Thus, the occupant can be warned with a clear image, while maintaining the design characteristics of the interior.

The vehicle according to the first aspect has an excellent advantageous effect in that a clear image can be displayed while maintaining the design characteristics of the interior.

The vehicle according to the second aspect has an excellent advantageous effect in that the strength of the interior material can be improved, while actualizing the design of the interior in a desired shape.

The vehicle according to the third aspect has an excellent advantageous effect in that an occupant can be allowed to visually recognize light emitted so as to flow in the vehicle front-rear direction, continuously without interruption.

The vehicle according to the fourth aspect has an excellent advantageous effect in that an occupant can be allowed to visually recognize light emitted so as to flow in the vehicle width direction, continuously without interruption.

The vehicle according to the fifth aspect has an excellent advantageous effect in that an occupant can be warned with a clear image, while maintaining the design characteristics of the interior.

### BRIEF DESCRIPTION OF THE DRAWINGS

An exemplary embodiment of the present disclosure will be described in detail based on the following figures, wherein:

FIG. 1 is a view of a front door of a vehicle according to the present exemplary embodiment, viewed from a vehicle cabin interior;

FIG. 2 is a view illustrating a case in which an image is displayed at the front door illustrated in FIG. 1;

FIG. 3 is a cross-sectional view taken along line 3-3 in FIG. 2;

FIG. 4 is a schematic view illustrating a mode of lamination of an interior material illustrated in FIG. 3;

FIG. 5 is a block diagram illustrating a hardware configuration of the vehicle illustrated in FIG. 1; and

FIG. 6 is a schematic view illustrating a pattern of through holes of a door trim of a vehicle according to a modified example.

### DETAILED DESCRIPTION

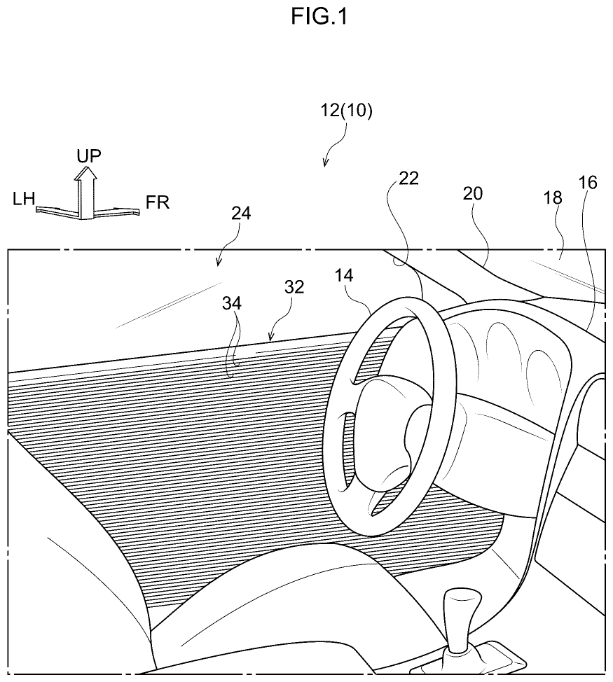

A vehicle 10 according to an exemplary embodiment of the present disclosure will be explained below, with reference to FIGS. 1 to 5. It should be noted that, in each of the drawings as appropriate, arrow FR, arrow UP, arrow LH, and arrow RH respectively indicate a front side, an upper side, a left-right direction (width direction) left side, and a left-right direction (width direction) right side of the vehicle 10. Further, unless specifically stated otherwise, in the following explanation, in cases in which front-rear, up-down, and left-right directions are used, these respectively indicate front and rear in a vehicle front-rear direction, up and down in a vehicle up-down direction, and left and right in a vehicle left-right direction (width direction).

FIG. 1 illustrates a vicinity of a driver's seat, viewed from a passenger seat side, within a vehicle cabin 12 of the vehicle 10 according to the present exemplary embodiment. As an example, the vehicle 10 is configured as a left-hand drive vehicle in which a steering wheel 14 is provided at the left side. The steering wheel 14 is attached at a vehicle rear side of an instrument panel 16 extending substantially in the vehicle width direction at a front portion of the vehicle cabin 12, and at a vehicle front side of the driver's seat.

A windshield glass 18 is disposed at an upper portion of the instrument panel 16. The windshield glass 18 is inclined at a downward slope toward the vehicle front side, and partitions an interior and an exterior of the vehicle cabin 12.

A left side end portion of the windshield glass 18 is fixed to a vehicle width direction inner side of a vehicle left side front pillar 20 extending substantially in the up-down direction. Similarly, a right side end portion of the windshield glass 18 is fixed to a vehicle right side front pillar (not illustrated in the drawings).

An upper end portion of the front pillar 20 is joined to a front end portion of a roof side rail (not illustrated in the drawings) extending substantially in the vehicle front-rear direction at a vehicle left side of a roof, which is not illustrated in the drawings. Further, a lower end portion of the front pillar 20 is joined to a front end portion of a rocker (not illustrated in the drawings) extending substantially in the vehicle front-rear direction at a vehicle left side of a floor, which is not illustrated in the drawings.

The front pillar 20, the roof side rail (not illustrated in the drawings), a center pillar (not illustrated in the drawings), and the rocker (not illustrated in the drawings) each have a closed cross-sectional structure, and configure a frame of the vehicle 10. A front door opening portion 22 surrounded by the front pillar 20, the roof side rail (not illustrated in the drawings), the center pillar (not illustrated in the drawings), and the rocker (not illustrated in the drawings) is formed at a left side portion of the vehicle 10. The front door opening portion 22 is configured to be opened and closed by a front door 24. An opening weather strip (not illustrated in the drawings) is attached to an opening edge of the front door opening portion 22.

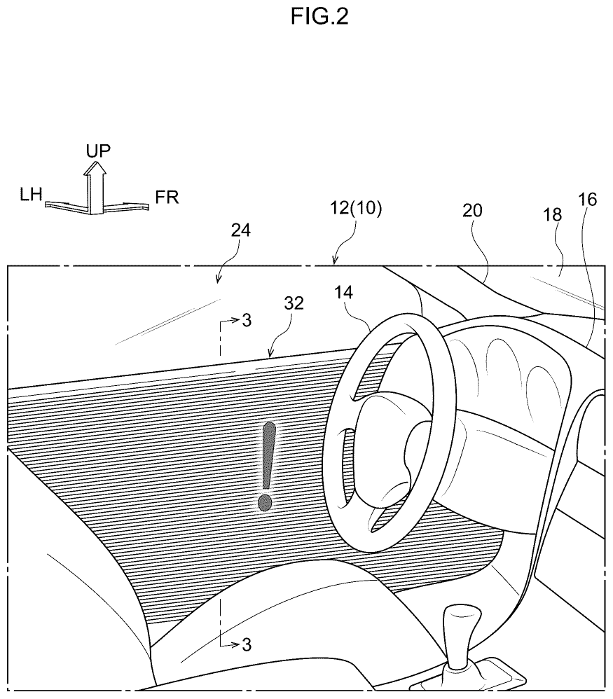

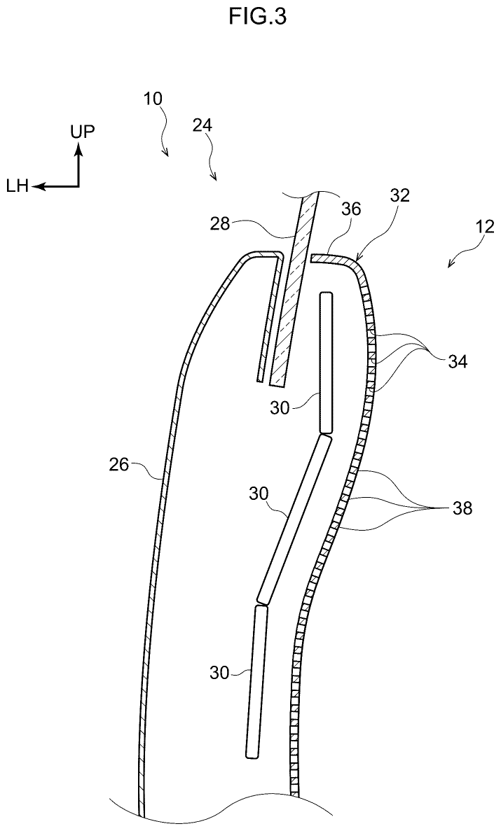

As illustrated in FIG. 2, the front door 24 is configured such that an image can be displayed at an inner side of the vehicle cabin 12. FIG. 3 illustrates a cross-sectional view of the front door 24 illustrated in FIG. 2, in which a cross-section taken along line 3-3 is viewed from the vehicle rear side. The front door 24 includes a door outer panel 26 disposed at a vehicle cabin outer side, and a door inner panel (not illustrated in the drawings) disposed at a vehicle cabin inner side, and has a closed cross-sectional structure. A door weather strip (not illustrated in the drawings) is attached to a peripheral edge portion of the front door 24.

A front side glass 28 is disposed between the door outer panel 26 and the door inner panel (not illustrated in the drawings). The front side glass 28 is capable of sliding in the up-down direction by a power window device (not illustrated in the drawings).

Further, plural displays 30, serving as a display device, are disposed substantially side-by-side in the vehicle up-down direction at a vehicle cabin 12 inner side of the door inner panel (not illustrated in the drawings) at a lower portion of the front door 24. The door inner panel (not illustrated in the drawings) is provided with concave portions that are concave toward the vehicle cabin outer side, and the plural displays 30 are disposed in the concave portions. Each display 30 is, as an example, a light-emitting diode (LED) display, and includes plural light-emitting diodes (not illustrated in the drawings), serving as light-emitting bodies, at a vehicle cabin 12 inner side. It should be noted that the displays are not limited to LED displays, and may be organic electro-luminescence (EL) displays. Furthermore, the display device is not limited to the displays, and may be configured by plural LEDs that are arrayed. Moreover, the arrangement of the displays is not limited to that which is described above, and may be arranged side-by-side in the vehicle front-rear direction, for example. The displays may also be configured by only one display.

A door trim 32, serving as an interior material configuring a design face of an interior of the vehicle cabin 12, is provided at a vehicle cabin 12 inner side of the displays 30. As an example, the door trim 32 is made of bamboo. The plural displays 30 are disposed tilted so as to conform to a shape of the door trim 32. It should be noted that the plural displays 30 may also be disposed on the same plane.

Plural slits 34 that penetrate in a thickness direction are formed at the door trim 32. The door trim 32 is disposed such that the plural slits 34 are positioned at a vehicle cabin inner side of the light-emitting diodes of the displays 30. The plural slits 34 are each formed in a linear shape along the vehicle front-rear direction, and are formed at regular intervals in the vehicle up-down direction at an inner side of a frame portion 36. As an example, a width in the vehicle up-down direction of each slit 34 and a width in the vehicle up-down direction of each of lattice portions 38 between the slits 34 are configured to be the same dimension.

It should be noted that the shape and dimensions of the slits 34 are not limited to that which is described above. For example, the dimension of each slit in the vehicle up-down direction may be larger than the dimension of each lattice portion in the vehicle up-down direction. In such cases, an occupant within the vehicle cabin 12 can more clearly see an image displayed at the displays 30. Further, the dimension of each slit in the vehicle up-down direction may be smaller than the dimension of each lattice portion in the vehicle up-down direction. In such cases, a texture of the door trim 32 when viewed from within the vehicle cabin 12 is emphasized, and design characteristics when no image is displayed at the displays 30 are improved. Moreover, the slits are not limited to a linear shape, and may be formed in a curved shape. For example, plural through holes may be disposed such that the entire door trim follows a predetermined pattern such as a wave shape, a radial shape or the like.

Although not illustrated in the drawings, an armrest, an inner handle, and a window switch are provided at the door trim 32. The armrest (not illustrated in the drawings) is disposed at an up-down direction central portion of the door trim 32, extends in the vehicle front-rear direction, and projects out toward the vehicle cabin 12 inner side. It should be noted that, aside from this, the door trim 32 may also include a storage pocket or a speaker. A front door (not illustrated in the drawings) at a front right side of the vehicle 10 has the same configuration as the front door 24, and explanation thereof is therefore omitted.

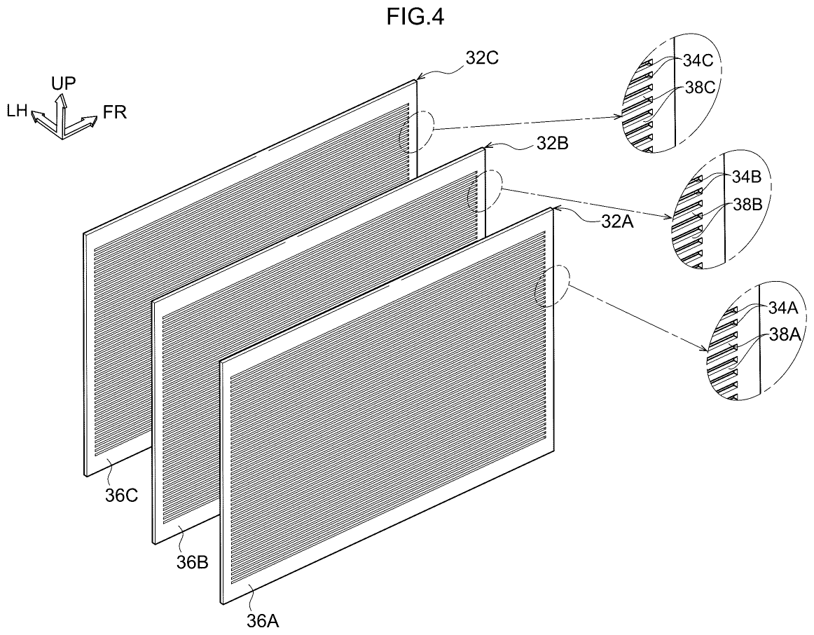

As illustrated in FIG. 4, the door trim 32 is a laminate body in which thin bamboo sheets 32A, 32B, and 32C, serving as sheet-like members, are superimposed in the thickness direction.

The bamboo sheet 32A is a thin sheet that is freely deformable, and plural slits 34A that penetrate in the thickness direction are formed therein. The plural slits 34A are each formed in a linear shape along the vehicle front-rear direction, and are disposed at regular intervals in the vehicle up-down direction at an inner side of a frame portion 36A.

The bamboo sheet 32B has the same configuration as the bamboo sheet 32A, and is configured to include a frame portion 36B, plural slits 34B, and plural lattice portions 38B. Similarly, the bamboo sheet 32C has the same configuration as the bamboo sheets 32A and 32B, and is configured to include a frame portion 36C, plural slits 34C, and plural lattice portions 38C.

The bamboo sheets 32A, 32B, and 32C are each laminated in a bent state according to a design of the front door 24, and are attached to each other. At this time, the bamboo sheets 32A, 32B, and 32C are superimposed such that positions of the respective slits 34A, 34B, and 34C coincide with each other in a sheet thickness direction (vehicle width direction). Consequently, a configuration is provided in which the slits 34 that penetrate in the thickness direction are formed at the laminated door trim 32. It should be noted that the door trim 32 of the vehicle 10 according to the present exemplary embodiment is configured such that the bamboo sheets 32A, 32B, and 32C are bonded at the entirety of their respective superimposed surfaces, but there is no limitation thereto. For example, the door trim may be bonded at only the frame portions of the respective bamboo sheets. Further, although the door trim 32 has been explained as one in which the three bamboo sheets 32A, 32B, and 32C are laminated, the number of sheet-like members to be laminated is not limited thereto. Moreover, in FIG. 4, for convenience of explanation, the bamboo sheets 32A, 32B, and 32C are each illustrated in a rectangular sheet shape, but in actuality, they are configured in a shape in accordance with a shape of the door trim 32.

### Hardware Configuration of Vehicle 10

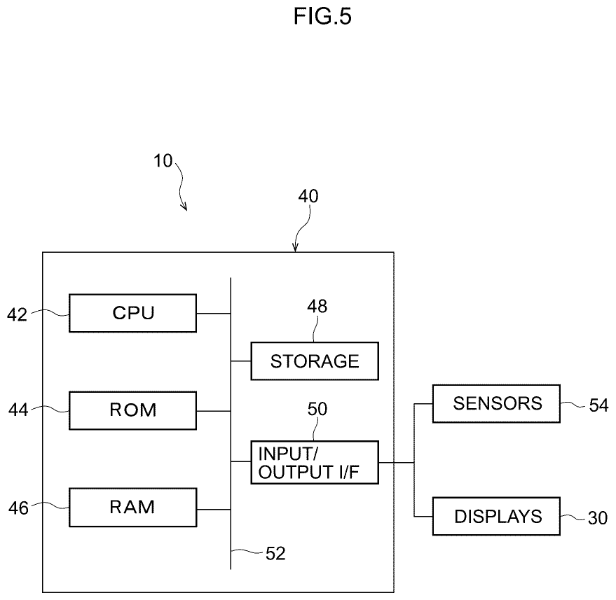

As illustrated in FIG. 5, the vehicle 10 is provided with an electronic control unit (ECU) 40. The ECU 40 is configured to include a CPU 42, a ROM 44, a RAM 46, a storage 48, and an input/output interface (input/output I/F) 50. The respective configurations are connected so as to be capable of communicating with each other via an internal bus 52.

The CPU 42 is a central arithmetic processing unit, and executes various programs and controls the respective portions. Namely, the CPU 42 reads out a program from the ROM 44 or the storage 48, and executes the program using the RAM 46 as a work area. Further, the CPU 42 carries out control of the displays 30 in accordance with a program recorded in the ROM 44 or the storage 48.

The ROM 44 stores various programs and various data. The RAM 46 temporarily stores programs or data as a work area. The storage 48 is configured by an HDD or an SSD, and is a non-transitory recording medium that stores various programs and various data.

The plural displays 30 and sensors 54, serving as periphery monitoring sensor that monitors a periphery of the vehicle 10, are connected to the input/output I/F 50. The sensors 54 include plural sensors from among various sensors such as a camera, radar, LiDAR (light detection and ranging), and the like. The camera photographs the periphery of the vehicle 10. The radar detects a distance and a direction with respect to an object at the periphery of the vehicle 10 using radio waves. The LiDAR detects a distance and a direction with respect to an object at the periphery of the vehicle 10 using laser light. It should be noted that the periphery monitoring sensor needs only to include at least one type of sensor from among these sensors.

The CPU 42 outputs various displays to the displays 30. As an example, in a case in which an obstacle approaching the vehicle 10 has been detected by the sensors 54, the CPU 42 outputs a warning display to the displays 30.

As an example, in at least one case from among a case in which another vehicle has approached the vehicle 10 from an oblique left rear side, or a case in which a two-wheeled vehicle is attempting to overtake the vehicle 10 by passing on a left side of the vehicle 10, the CPU 42 causes an image simulating an exclamation point, serving as a warning display, to be displayed at the front door 24 at the vehicle left side as illustrated in FIG. 2. On the other hand, in at least one case from among a case in which another vehicle has approached the vehicle 10 from an oblique right rear side, or a case in which a two-wheeled vehicle is attempting to overtake the vehicle 10 by passing on a right side of the vehicle 10, the warning display is output at the displays (not illustrated in the drawings) of the front door at the vehicle right side. Consequently, an occupant can instantaneously recognize vehicles respectively approaching from the left and right rear sides. It should be noted that, in FIG. 2, the display is illustrated in an exaggerated manner for convenience of explanation, but that, in actuality, light passing through the slits 34 (refer to FIG. 3 and FIG. 4) is clearly displayed. Further, although the image simulating an exclamation point is displayed in FIG. 2 as an example, the warning display is not limited thereto.

Moreover, for example, in at least one case from among a case in which a speed of the vehicle 10 is exceeding a legal speed limit, or a case in which the speed of the vehicle 10 is likely to exceed the legal speed limit, the CPU may display an image at at least one front door from among the front door 24 at the vehicle left side or the front door (not illustrated in the drawings) at the vehicle right side, such that light flows from the vehicle front side toward the vehicle rear side. Consequently, the driver can recognize that the speed of the vehicle 10 is excessively high, as a bodily sensation within the vehicle cabin 12.

Further, the CPU 42 may output, to the displays 30, an image that creates an atmosphere for a space within the vehicle cabin 12. For example, an outside air temperature may be acquired from an outside air temperature sensor (not illustrated in the drawings), a warm color-based display may be output when the outside air temperature is low, and a cold color-based display may be output at the displays 30 when the outside air temperature is high. Consequently, the occupant can be made to feel warm with the warm color-based display on a cold day, and can be made to feel cool with the cold color-based display on a hot day, due to a visual effect. It should be noted that there is no limitation to the outside air temperature sensor, and that the CPU 42 may acquire a body temperature of the occupant from a biosensor (not illustrated in the drawings) that acquires biometric information of the occupant, output the warm color-based display when the body temperature is low, and output the cold color-based display to the displays 30 when the body temperature is high.

Moreover, for example, based on the information acquired from the biosensor (not illustrated in the drawings), the CPU 42 may output a relaxing image to the displays 30 in a case in which the occupant is tense. Further, for example, the CPU 42 may output, at the displays 30, an image that attracts attention of the occupant and prompts wakefulness in a case in which the occupant is drowsy. Furthermore, for example, the CPU 42 may output, at the displays 30, an image linked to music that is output from a speaker (not illustrated in the drawings) within the vehicle cabin 12. As an example, these images that create an atmosphere for the space within the vehicle cabin 12 are always output to the displays 30 when power of the vehicle 10 is on. It should be noted that a timing at which the images are output is not limited thereto, and, for example, the CPU 42 may output the images at the displays 30 at a timing at which the exterior of the vehicle cabin 12 becomes dark based on information that has been acquired from an illuminance sensor (not illustrated in the drawings).

### Operation of Present Embodiment

Next, operation of the vehicle 10 according to the present exemplary embodiment will be explained.

In the vehicle 10 according to the present exemplary embodiment, the displays 30 are covered by the door trim 32. Thus, design characteristics of the interior when the light-emitting diodes (not illustrated in the drawings) are not emitting light can be maintained, compared to a case in which the displays 30 are exposed within the vehicle cabin 12.

Further, light emitted from the light-emitting diodes of the displays 30 passes through the slits 34 of the door trim 32 and reaches the space within the vehicle cabin 12. Thus, compared to a case in which a panel having transparency is disposed at the inner side of the displays 30, since the light emitted from the light-emitting diodes directly reaches the space within the vehicle cabin 12, a clear image can be displayed.

Furthermore, in the vehicle 10 according to the present exemplary embodiment, the bamboo sheets 32A, 32B, and 32C are each thin and freely bendable. Thus, by laminating the bamboo sheets 32A, 32B, and 32C after bending them, strength of the door trim 32 can be secured while conforming to a three-dimensional shape of the interior of the vehicle cabin 12.

Moreover, in the vehicle 10 according to the present exemplary embodiment, the slits 34 of the door trim 32 are formed along the vehicle front-rear direction at the front door 24. Thus, light emitted so as to flow in the vehicle front-rear direction can be visually recognized by the occupant continuously without interruption.

Further, in the vehicle 10 according to the present exemplary embodiment, in a case in which an obstacle has been detected at the periphery of the vehicle 10 by the sensors 54, the warning display is displayed at the displays 30. The occupant can visually recognize the warning display from the slits 34 formed at the door trim 32. Thus, the occupant can be warned with a clear image, while maintaining the design characteristics of the interior of the vehicle cabin 12.

Furthermore, in the vehicle 10 according to the present exemplary embodiment, the slits 34A are formed in the bamboo sheet 32A, the slits 34B are formed in the bamboo sheet 32B, and the slits 34C are formed in the bamboo sheet 32C. Namely, since the slits 34A, 34B, and 34C are respectively formed in the thin bamboo sheets 32A, 32B, and 32C, the processing at the time of forming the slits 34A, 34B, and 34C is easy, and damage to members can be suppressed, compared to a manufacturing method in which through holes are formed after laminating sheet-like members. It should be noted that the interior material may be configured by forming through holes after laminating the sheet-like members.

### Supplementary Explanation of Above Exemplary Embodiment

In the above exemplary embodiment, an explanation has been given in which the displays 30 are provided at the front door 24, and the plural slits 34 are formed at the door trim 32, but there is no limitation thereto.

For example, the display device may be provided at an interior of an instrument panel, and slits having length directions along the vehicle width direction may be formed in a panel trim that covers the display device. In such a case, light emitted so as to flow in the vehicle width direction can be visually recognized by the occupant continuously without interruption. Further, in such a case, the warning display may be output at the display device of the instrument panel when the vehicle is too close to a preceding vehicle.

Furthermore, for example, the display device may be provided at another location within the vehicle cabin, such as a rear door, a back door, a roof, a floor or the like, and, in such a case, slits are formed in a corresponding interior material. For example, the display device may be provided at a rear door of a taxi, and a relaxing image may be displayed at the display device for a passenger. Further, plural display devices may be provided within the vehicle cabin at a combination of the plural locations described above. Furthermore, through holes may be formed not only at the interior material that covers the display device, but also at an interior material at other portions within the vehicle cabin. Consequently, a sense of uniformity in the design within the vehicle cabin is achieved, and design characteristics are improved.

Moreover, in the above exemplary embodiment, although the door trim 32 has been described as a laminate body in which the bamboo sheets 32A, 32B, and 32C are superimposed, there is no limitation thereto, and the door trim 32 may be configured from a single member that is not laminated.

Further, the interior material is not limited to bamboo, and may be configured by other materials. For example, the interior material may be a wood material configured by laminating plural wooden sheets including through holes. Alternatively, for example, the interior material may be configured by weaving rattan such that light passes through woven stitches. Thus, by using a natural material as the interior material, an occupant can be made to feel a natural warmth. Further, although environmental impact can be reduced by reducing a use amount of interior materials formed from chemical products or the like, the interior material may be configured by an artificial material such as a resin or the like.

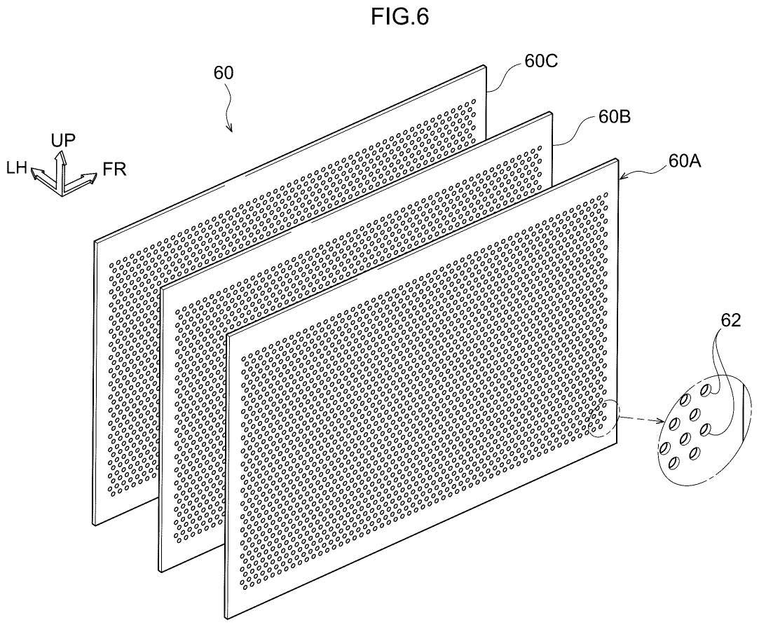

Moreover, in the above exemplary embodiment, an explanation has been given in which the plural slits 34 having length directions in the vehicle front-rear direction are formed at the door trim 32, but there is no limitation thereto. For example, plural slits may be formed at the door trim with length directions thereof along the vehicle up-down direction. Further, the shape of each through hole is not limited to a slit. As in the modified example illustrated in FIG. 6, for example, plural circular-shaped through-holes 62 may be formed in each of sheet-like members 60A, 60B, and 60C configuring a door trim 60. Further, it should be noted that the shapes and sizes of the plural through holes are not necessarily the same. Moreover, the through holes are not necessarily arranged at regular intervals. For example, by expressing shading by the density of the plural through holes, a configuration may be provided in which a pattern including a specific picture or text appears at the interior material when the display device is turned off.

With regard to the above-described exemplary embodiment, the following additional notes are further disclosed.

### Additional Note 1

A vehicle comprising:
a display device that includes a plurality of light-emitting bodies at a vehicle cabin inner side; and
an interior material that has a plurality of through holes penetrating in a thickness direction formed therein, and that is disposed at a vehicle cabin inner side of the display device so as to cover the display device.

### Additional Note 2

The vehicle according to Additional Note 1, wherein the interior material is configured as a laminate body in which a plurality of sheet-like members are superimposed in the thickness direction.

### Additional Note 3

The vehicle according to Additional Note 1 or Additional Note 2, wherein the interior material is provided at a door that is disposed at a side portion of the vehicle, and the through holes are configured as slits that each have a length direction thereof along a vehicle front-rear direction.

### Additional Note 4

The vehicle according to Additional Note 1 or Additional Note 2, wherein the interior material is provided at an instrument panel that extends in a vehicle width direction at a front portion of the vehicle cabin, and the through holes are configured as slits that each have a length direction thereof along the vehicle width direction.

### Additional Note 5

The vehicle according to any one of Additional Note 1 to Additional Note 4, further comprising a periphery monitoring sensor that monitors a periphery of the vehicle,
wherein the display device displays a warning in a case in which an obstacle has been detected at the periphery of the vehicle by the periphery monitoring sensor.

What is claimed is:

1. A vehicle comprising:
a display device that includes a plurality of light-emitting bodies at a vehicle cabin inner side; and
an interior material that has a plurality of through holes penetrating in a thickness direction formed therein, and that is disposed at a vehicle cabin inner side of the display device so as to cover the display device.

2. The vehicle according to claim 1, wherein the interior material is configured as a laminate body in which a plurality of sheet-like members are superimposed in the thickness direction.

3. The vehicle according to claim 1, wherein the interior material is provided at a door that is disposed at a side portion of the vehicle, and the through holes are configured as slits that each have a length direction thereof along a vehicle front-rear direction.

4. The vehicle according to claim 1, wherein the interior material is provided at an instrument panel that extends in a vehicle width direction at a front portion of the vehicle cabin, and the through holes are configured as slits that each have a length direction thereof along the vehicle width direction.

5. The vehicle according to claim 1, further comprising a periphery monitoring sensor that monitors a periphery of the vehicle,
wherein the display device displays a warning in a case in which an obstacle has been detected at the periphery of the vehicle by the periphery monitoring sensor.

6. The vehicle according to claim 1, wherein a plurality of display devices are provided side-by-side, and the plurality of display devices are disposed tilted so as to conform to a shape of the interior material.

7. The vehicle according to claim 1, wherein the interior material is disposed such that the plurality of through holes are positioned at a vehicle cabin inner side of the plurality of light-emitting bodies of the display device.

8. The vehicle according to claim 2, wherein each of the plurality of sheet-like members is a thin sheet that is freely deformable, and is laminated in a bent state according to a design of the interior material.

9. The vehicle according to claim 3, wherein each of the plurality of through holes is formed in a linear shape along the vehicle front-rear direction, and is formed at regular intervals in a vehicle up-down direction at an inner side of a frame portion.

10. The vehicle according to claim 5, wherein:
the interior material is provided at a front door of the vehicle, and
in a case in which another vehicle has approached from an oblique rear side at one side in a vehicle width direction, the display device displays the warning at the front door at the one side in the vehicle width direction.

11. The vehicle according to claim 5, wherein:
the interior material is provided at a front door of the vehicle, and
in a case in which a two-wheeled vehicle is attempting to overtake the vehicle by passing on one side in a vehicle width direction, the display device displays the warning at the front door at the one side in the vehicle width direction.

12. The vehicle according to claim 3, wherein:
the interior material is provided at at least one of a front door at a vehicle left side or a front door at a vehicle right side, and
in at least one case from among a case in which a speed of the vehicle is exceeding a legal speed limit, or a case in which the speed of the vehicle is likely to exceed the legal speed limit, the display device displays an image at at least one front door of the front door at the vehicle left side or the front door at the vehicle right side, such that light flows from a vehicle front side toward a vehicle rear side.

13. The vehicle according to claim 1, wherein the display device displays an image that creates an atmosphere for a space within the vehicle cabin.

14. The vehicle according to claim 1, further comprising an outside air temperature sensor that acquires an outside air temperature of the vehicle,
wherein the display device displays a warm color-based image when the outside air temperature acquired by the outside air temperature sensor is low, and displays a cold color-based image when the outside air temperature acquired by the outside air temperature sensor is high.

15. The vehicle according to claim 1, further comprising a biosensor that acquires biometric information of an occupant,
wherein, based on the biometric information acquired by the biosensor, the display device displays a relaxing image in a case in which the occupant is tense, and displays an image that attracts attention of the occupant and prompts wakefulness in a case in which the occupant is drowsy.
